(19) United States
(12) Patent Application Publication
(10) Pub. No.: US 2019/0372122 A1
(43) Pub. Date: Dec. 5, 2019

(54) LITHIUM SECONDARY BATTERY FOR VEHICLES AND METHOD FOR MANUFACTURING THE SAME

(71) Applicants: HYUNDAI MOTOR COMPANY, Seoul (KR); KIA MOTORS CORPORATION, Seoul (KR)

(72) Inventors: Jong Chan SONG, Suwon-si (KR); Gwang Seok OH, Seoul (KR); Ji Yong LEE, Seongnam-si (KR)

(21) Appl. No.: 16/206,285

(22) Filed: Nov. 30, 2018

(30) Foreign Application Priority Data
Jun. 5, 2018 (KR) 10-2018-0064626

(51) Int. Cl. H01M 4/62; H01M 12/08; H01M 4/134; H01M 4/1395; H01M 4/36; H01M 4/38; H01M 4/04

(52) U.S. Cl. CPC H01M 4/628; H01M 12/08; H01M 4/134; H01M 2004/027; H01M 4/366; H01M 4/382; H01M 4/0402; H01M 4/1395

(57) ABSTRACT

A lithium secondary battery for vehicles includes a negative electrode including lithium, a negative electrode coating layer provided on the negative electrode and including a disulfide polymer, an electrolyte layer provided on the negative electrode coating layer, and a positive electrode provided on the electrolyte layer. The disulfide polymer has a molecular weight of 1,000 to 10,000,000. A polymer loading level of the negative electrode coating layer is 0.025 to 0.25 mg/cm². A mass loading level of the negative electrode coating layer is 1 to 1,000 μg·cm⁻². The negative electrode coating layer has a thickness smaller than that of the negative electrode. The negative electrode coating layer further includes an inorganic substance. The inorganic substance includes at least one of Al₂O₃, SiO₂, TiO₂, or mixtures thereof

### CROSS-REFERENCE TO RELATED APPLICATION

This application claims, under 35 U.S.C. § 119(a), the benefit of priority to Korean Patent Application No. 10-2018-0064626 filed on Jun. 5, 2018, the entire contents of which are incorporated herein by reference.

### BACKGROUND

### (a) Technical Field

The present disclosure relates to a lithium secondary battery for vehicles and a method for manufacturing the same.

### (b) Background Art

Lithium secondary batteries attract a great deal of attention as next-generation energy sources for vehicles. There is a need for development of lithium secondary batteries with long lifespan and high charge/discharge capacity in order to use lithium secondary batteries as energy sources for vehicles.

KR 10-2014-0023548 A, KR 10-2016-0103998 A, KR 10-2015-0145046 A and KR 10-2015-0166976 A disclose related technologies of secondary batteries.

The above information disclosed in this Background section is provided only for enhancement of understanding of the background of the invention and therefore it may contain information that does not form the prior art that is already known in this country to a person of ordinary skill in the art.

### SUMMARY OF THE DISCLOSURE

One aspect of the present invention provides a lithium secondary battery for vehicles that is capable of exhibiting long lifespan and high efficiency by improving the reversibility of lithium.

Another aspect of the present invention provides a method for manufacturing a lithium secondary battery for vehicles that is capable of exhibiting long lifespan and high efficiency by improving the reversibility of lithium.

Still another aspect of the present invention provides a lithium secondary battery for vehicles including a negative electrode including lithium, a negative electrode coating layer provided on the negative electrode and including a disulfide polymer, an electrolyte layer provided on the negative electrode coating layer, and a positive electrode provided on the electrolyte layer.

The disulfide polymer is represented by the following Formula 1:

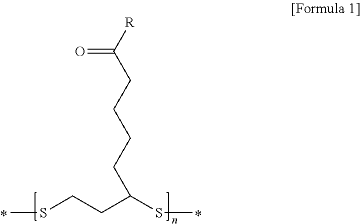

wherein R is —OXₐ or —NHX_{b}, in which Xₐ is an element selected from the group consisting of H, Li, Na, K, Cs, Ca, Mg, Fe, Co, Ni, Cu, Zn, Al, or mixtures thereof, and X_{b} is a functional group selected from the group consisting of halogen, an aryl group, an aralkyl group, a phenyl group, or mixtures thereof.

The disulfide polymer may have a molecular weight of 1,000 to 10,000,000.

A polymer loading level of the negative electrode coating layer may be 0.025 to 0.25 mg/cm².

A mass loading level of the negative electrode coating layer may be 1 to 1,000 μg·cm⁻².

A thickness of the negative electrode coating layer may be less than a thickness of the negative electrode.

The negative electrode coating layer may further include an inorganic substance.

The inorganic substance may include at least one of Al₂O₃, SiO₂, TiO₂, or mixtures thereof

A further aspect of the present invention provides a method for manufacturing a lithium metal air battery for vehicles including providing a negative electrode including lithium, providing a negative electrode coating layer including a disulfide polymer on the negative electrode, providing an electrolyte layer on the negative electrode coating layer, and providing a positive electrode on the electrolyte layer.

In the providing the negative electrode coating layer, the disulfide polymer may be represented by the following Formula 1:

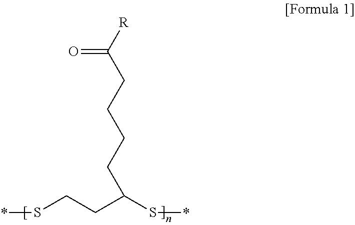

wherein R is —OXₐ or —NHX_{b}, in which Xₐ is an element selected from the group consisting of H, Li, Na, K, Cs, Ca, Mg, Fe, Co, Ni, Cu, Zn, Al, or mixtures thereof, and X_{b} is a functional group selected from the group consisting of halogen, an aryl group, an aralkyl group, a phenyl group, or mixtures thereof.

The providing a negative electrode coating layer may include preparing a cyclic disulfide monomer represented by the following Formula 2:

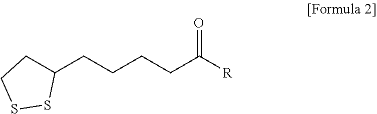

wherein R is —OXₐ or —NHX_{b}, in which Xₐ is an element selected from the group consisting of H, Li, Na, K, Cs, Ca, Mg, Fe, Co, Ni, Cu, Zn, Al, or mixtures thereof, and X_{b} is a functional group selected from the group consisting of halogen, an aryl group, an aralkyl group, a phenyl group, or mixtures thereof; and polymerizing the cyclic disulfide monomer to form the disulfide polymer represented by Formula 1.

The formation of the disulfide polymer may be carried out by applying heat or light.

The formation of the disulfide polymer may be carried out at 100 to 140° C. for 2 to 4 hours.

In the providing a negative electrode coating layer, the disulfide polymer may have a molecular weight of 1,000 to 10,000,000.

### BRIEF DESCRIPTION OF THE DRAWINGS

The above and other features of the present invention will now be described in detail with reference to certain embodiments thereof illustrated in the accompanying drawings which are given herein below by way of illustration only, and thus are not limitative of the present invention, and wherein:

FIG. 1 is a schematic sectional view illustrating a lithium secondary battery for vehicles according to an embodiment of the present invention;

FIG. 2 is a flowchart schematically illustrating a method for manufacturing a lithium secondary battery for vehicles according to an embodiment of the present invention;

FIG. 3A shows SEM analysis results of the surface of a negative electrode coating layer;

FIG. 3B shows SEM analysis results of side surfaces of a negative electrode and the negative electrode coating layer;

FIG. 4A shows SEM analysis results of the surface of a negative electrode coating layer surface of Example 1 after 5 charge/discharge cycle testing;

FIG. 4B shows SEM analysis results of the surface of the negative electrode coating layer surface of Example 1 after 5 charge/discharge cycle testing;

FIG. 5 is a graph showing voltage-capacity variation behaviors based on charge/discharge testing at 0.34 mA·cm⁻² regarding Examples 1 and 2, and Comparative Example 1; and

FIG. 6 is a graph showing a voltage with time, measured under conditions of 0.1 mA·cm⁻² and 10 hour/half-cycle regarding Example 3, Comparative Example 2 and Comparative Example 3.

### DETAILED DESCRIPTION

The aspects, features and advantages will be clearly understood from embodiments with reference to the annexed drawings. However, the present invention is not limited to the embodiments and will be embodied in different forms. The embodiments are suggested only to offer thorough and complete understanding of the disclosed context and sufficiently inform those skilled in the art of the technical concept of the present invention.

Like reference numbers refer to like elements throughout the description of the figures. In the drawings, the sizes of structures are exaggerated for clarity. It will be understood that, although the terms “first”, “second”, etc. may be used herein to describe various elements, these elements should not be limited by these terms and are used only to distinguish one element from another. For example, within the scope defined by the present invention, a first element may be referred to as a second element and, similarly, a second element may be referred to as a first element. Singular forms are intended to include plural forms as well, unless context clearly indicates otherwise.

It will be further understood that the terms “comprise,” “comprises,” “has” and/or “has”, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that when an element such as a layer, film, region or substrate is referred to as being “under” another element, it can be directly under the other element or an intervening element may also be present.

One example of secondary batteries suggests suppression of dendrite growth using inorganic particles with high rigidity. Another example suggests induction of uniform lithium plating. A further example suggests inhibition of electrolyte degradation. The above technologies have a limitation of failing to suggest a suitable solution associated with reversibility of the negative electrode, i.e., the lithium electrode.

Hereinafter, the lithium secondary battery for vehicles according to an embodiment of the present invention will be described below.

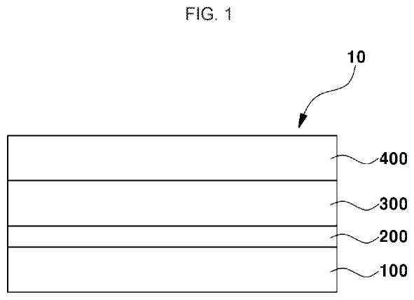

FIG. 1 is a schematic sectional view illustrating a lithium secondary battery for vehicles according to an embodiment of the present invention.

Referring to FIG. 1, the lithium secondary battery 10 for vehicles according to an embodiment of the present invention may be used as an energy source for vehicles. The vehicle may be a means used to transport an object, a person or the like. The vehicle may be, for example, a land vehicle, a marine vessel or an aircraft. Examples of the land vehicle may include cars including passenger cars, vans, trucks, trailer trucks and sports cars, bicycles, motorcycles, trains and the like. Examples of the marine vessel may include ships and submarines. Examples of the aircraft may include airplanes, hang gliders, hot air balloons, helicopters and small aircraft such as drones.

The lithium secondary battery 10 for vehicles according to an embodiment of the present invention undergoes electrochemical reaction by charge/discharge. When charging, oxidation/reduction reaction of metal or oxidation/reduction reaction of oxygen occurs at a positive electrode 400. At this time, electrons are also generated and can be moved to a negative electrode 100, for example, through an exterior circuit. At the negative electrode 100, oxygen molecules, lithium ions and electrons react together to produce electric energy and thermal energy. When discharging, lithium ions are discharged from the negative electrode 100 and are moved to the positive electrode 400 through an electrolyte layer 300. The electrons are, for example, moved through the exterior circuit, to the positive electrode 400.

The lithium secondary battery 10 for vehicles according to an embodiment of the present invention is not particularly limited so long as the negative electrode 100 includes lithium, for example, all-solid-state batteries, lithium ion batteries, metal air batteries and the like.

The lithium secondary battery 10 for vehicles according to an embodiment of the present invention includes a negative electrode 100, a negative electrode coating layer 200, an electrolyte layer 300 and a positive electrode 400.

The negative electrode 100 includes lithium. A thickness of the negative electrode 100 may be greater than a thickness of the negative electrode coating layer 200.

In embodiments, the negative electrode coating layer 200 is provided on the negative electrode 100. The negative electrode coating layer 200 includes a disulfide polymer. In general, as charge/discharge of the lithium secondary battery for vehicles occurs, the electrolyte is decomposed between the negative electrode and the electrolyte layer, and lithium dendrites and the like are accumulated, forming a porous layer. At this time, when the porous layer is spaced from the lithium metal connected to a current collector, lithium reversibility is deteriorated due to insufficient electrical contact. The lithium secondary battery for vehicles according to an embodiment of the present invention includes a negative electrode coating layer including a disulfide polymer, to prevent or inhibit the porous layer from being spaced from the negative electrode. Accordingly, the electron conduction channel is maintained, so that high reversibility of lithium can be maintained even upon continuous charge/discharge. In one embodiment, the negative electrode coating layer is formed directly on the negative electrode, and in another embodiment, another layer may be interposed between the negative electrode coating layer and the negative electrode.

The negative electrode coating layer 200 includes a disulfide polymer and thus has high adhesiveness and resilience. The molecular weight of the disulfide polymer may be 1,000 to 10,000,000. When the molecular weight of the disulfide polymer is less than the range defined above, the adhesiveness of the negative electrode coating layer 200 is deteriorated and the physical form of the coating layer cannot be retained well, so reversibility of lithium may be deteriorated, and when the molecular weight of the disulfide polymer is greater than the range, lithium ionic conductivity in the negative electrode coating layer 200 may be rapidly deteriorated.

For example, the disulfide polymer may be represented by the following Formula 1:

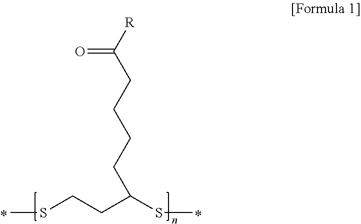

wherein R is —OXₐ or —NHX_{b}, in which Xₐ is an element selected from the group consisting of H, Li, Na, K, Cs, Ca, Mg, Fe, Co, Ni, Cu, Zn, Al, or mixtures thereof, X_{b} is a functional group selected from the group consisting of halogen, an aryl group, an aralkyl group, a phenyl group, or mixtures thereof;

n is an appropriate natural number calculated within the range of a molecular weight of the disulfide polymer; and

“*” represents bonding to an adjacent functional group or compound.

The thickness of the negative electrode coating layer 200 may be less than the thickness of the negative electrode 100. When the thickness of the negative electrode coating layer 200 is greater than or the same as the thickness of the negative electrode 100, movement of lithium ions may be difficult due to increased resistance of the coating layer. For example, the thickness of the negative electrode coating layer 200 may be about 0.1 μm to about 10 μm.

The polymer loading level of the negative electrode coating layer 200 may be about 0.025 mg/cm² to about 0.25 mg/cm². When the polymer loading level is less than the range defined above, the adhesiveness of the negative electrode coating layer 200 may be deteriorated and reversibility of lithium may thus be deteriorated, and when the polymer loading level is greater than the range, it may be difficult for lithium ions to pass through the negative electrode coating layer 200.

The negative electrode coating layer 200 may further include an inorganic substance. The inorganic substance can improve rigidity of the negative electrode coating layer 200. The inorganic substance, for example, includes at least one of Al₂O₃, SiO₂, or TiO₂. In embodiments, the surface mass loading level of the negative electrode coating layer may be about 1 μg·cm⁻² to about 1,000 μg·cm⁻².

The electrolyte layer 300 may be provided on the negative electrode coating layer 200. The electrolyte layer 300 may include a liquid electrolyte or a solid electrolyte.

The electrolyte layer may include a carbonate-based electrolyte. The term “˜-based” used herein may mean that a compound includes a compound corresponding to “˜” or a derivative of “˜”. The term “derivative” means a compound which is modified by introduction of a functional group, oxidation, reduction, or substitution or the like, of an atom, from a certain compound as a precursor while retaining the structure and characteristics of the precursor.

The electrolyte layer 300 includes, for example, LiPF₆. The electrolyte layer 300 includes, for example, LiPF₆ included in ethylene carbonate (EC) and di-ethyl carbonate (DEC).

The positive electrode 400 is provided on the electrolyte layer 300. The positive electrode 400 is not particularly limited so long as it can constitute the lithium secondary battery 10.

In general, as charge/discharge of the lithium secondary battery for vehicles occurs, the electrolyte is decomposed between the negative electrode and the electrolyte layer, and lithium dendrites and the like are accumulated to form a porous layer. At this time, when the porous layer is spaced from the negative electrode, reversibility of lithium between the negative electrode and the electrolyte layer is deteriorated. The lithium secondary battery for vehicles according to an embodiment of the present invention includes a negative electrode coating layer including a disulfide polymer, to prevent or inhibit the porous layer from being spaced from the negative electrode. Accordingly, reversibility of lithium can be improved. In addition, the lifespan of the lithium secondary battery can be increased, and charge/discharge capacity can be increased.

Hereinafter, a method for manufacturing the lithium secondary battery for vehicles according to an embodiment of the present invention will be described below. The following detailed description focuses on the difference from the lithium secondary battery for vehicles according to an embodiment of the present invention described above and the same features as the lithium secondary battery for vehicles according to an embodiment of the present invention described above are omitted.

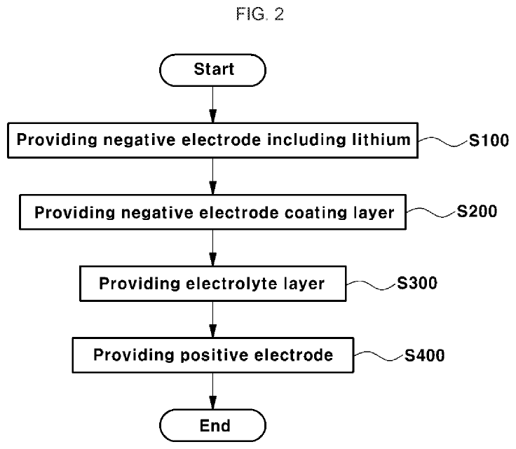

FIG. 2 is a flowchart schematically illustrating a method for manufacturing a lithium secondary battery for vehicles according to an embodiment of the present invention.

Referring to FIGS. 1 and 2, the method for manufacturing a lithium metal air battery for vehicles according to an embodiment of the present invention includes providing a negative electrode 100 including lithium (S100), providing a negative electrode coating layer 200 including a disulfide polymer on the negative electrode 100 (S200), providing an electrolyte layer 300 on the negative electrode coating layer 200 (S300) and providing a positive electrode 400 on the electrolyte layer 300 (S400).

The negative electrode 100 is provided (S100). The negative electrode 100 may include lithium.

The negative electrode coating layer 200 is provided on the negative electrode 100 (S200). The negative electrode coating layer 200 includes a disulfide polymer. The molecular weight of the disulfide polymer may be about 1,000 to about 10,000,000. When the molecular weight of the disulfide polymer is less than the range defined above, the adhesiveness of the negative electrode coating layer 200 is deteriorated, the physical form of the coating layer cannot be retained well, and reversibility of lithium may be deteriorated, and when the molecular weight of the disulfide polymer is greater than the range defined above, the lithium ionic conductivity at the negative electrode coating layer 200 may be rapidly deteriorated.

In the step of providing the negative electrode coating layer 200 (S200), the disulfide polymer may be represented by the following Formula 1:

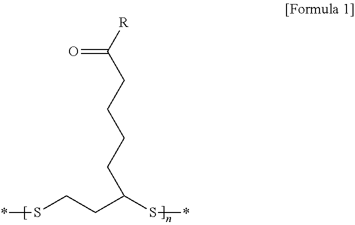

wherein R is —OXₐ or —NHX_{b} in which Xₐ is an element selected from the group consisting of H, Li, Na, K, Cs, Ca, Mg, Fe, Co, Ni, Cu, Zn, Al, or mixtures thereof, and X_{b} is a functional group selected from the group consisting of halogen, an aryl group, an aralkyl group, a phenyl group, or mixtures thereof; and

n is defined as above.

The step of providing the negative electrode coating layer 200 (S200) may include providing acyclic disulfide monomer represented by the following Formula 2:

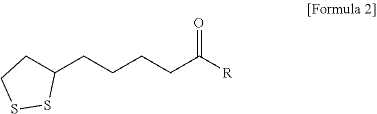

R is —OXₐ or —NHX_{b}, in which Xₐ is an element selected from the group consisting of H, Li, Na, K, Cs, Ca, Mg, Fe, Co, Ni, Cu, Zn, Al, or mixtures thereof, and X_{b} is a functional group selected from the group consisting of halogen, an aryl group, an aralkyl group, a phenyl group, or mixtures thereof; and

polymerizing the cyclic disulfide monomer, to form the disulfide polymer represented by Formula 1.

The formation of the disulfide polymer may be carried out by applying heat or light. For example, the formation of the disulfide polymer is carried out at about 100° C. to about 140° C. for about 2 hours to about 4 hours. When the temperature and time are within the range defined above, polymerization may not be sufficiently performed, and when the temperature and time are not within the range defined above, the disulfide polymer is not dissolved in a coating solution due to lengthened chains of the disulfide polymer.

The step of providing the negative electrode coating layer 200 (S200) may include preparing a coating solution and dropping the coating solution to form a negative electrode coating layer 200.

The step of preparing a coating solution may be carried out by supplying a disulfide polymer to a solution. The solution may be, for example, dimethyl ether (DME). The disulfide polymer may be supplied in an amount of about 0.1% to about 10.0% by weight, based on the total weight of the coating solution. By changing the concentration of polymer in the solution, the thickness or density of the negative electrode coating layer can be controlled.

The polymer loading level of the negative electrode coating layer 200 may be about 0.025 mg/cm² to about 0.25 mg/cm². The adhesiveness of the negative electrode coating layer 200 is deteriorated and the physical form of the coating layer cannot be retained well, so reversibility of lithium may be deteriorated, and when the molecular weight of the disulfide polymer is greater than the range, lithium ionic conductivity at the negative electrode coating layer 200 may be rapidly deteriorated.

The coating solution is dropped and dried to form the negative electrode coating layer 200. For example, drying may be carried out at room temperature.

The electrolyte layer 300 is provided on the negative electrode coating layer 200 (S300). The electrolyte layer 300 may include a liquid electrolyte or a solid electrolyte.

The positive electrode 400 is provided on the electrolyte layer 300 (S400). The electrolyte layer may include a carbonate-based electrolyte.

The positive electrode 400 is not particularly limited so long as it can constitute the lithium secondary battery 10, but a positive electrode coating layer including a disulfide polymer may be further provided between the positive electrode 400 and the electrolyte layer 300. The disulfide polymer may be the same as or different from the polymer included in the negative electrode coating layer.

In embodiments, the negative electrode 100 and the positive electrode 400 may be separated from each other by a separator. The separator, for example, includes polypropylene.

In general, as charge/discharge of the lithium secondary battery for vehicles occurs, a porous layer is formed between the negative electrode and the electrolyte layer. At this time, when the porous layer is spaced from the negative electrode, reversibility of lithium between the negative electrode and the electrolyte layer is deteriorated. The method for manufacturing a lithium secondary battery for vehicles according to an embodiment of the present invention includes providing a negative electrode coating layer including a disulfide polymer, so that detachment of the porous layer from the negative electrode can be prevented. Accordingly, reversibility of lithium can be improved. In addition, the lifespan of the lithium secondary battery can be increased and charge/discharge capacity can be improved.

Hereinafter, the present invention will be described in more detail with reference to specific examples. However, the examples are provided only for illustration of the present invention and should not be construed as limiting the range of the present invention.

### EXAMPLE

Synthesis of Disulfide Polymer

An alpha-lipoic acid (ALA) represented by the following Formula 3 was prepared and was polymerized at 120° C. for 3 hours. When the ALA monomer was polymerized to form a poly-ALA, a yellow gel with high viscosity was obtained.

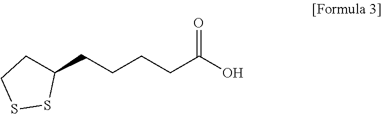 [SMILES: O=C(O)CCCC[C@@H]1CCSS1]

Preparation of Coating Solution

Poly-ALA is not dissolved in polycarbonate (PC), but is dissolved well in DME. Accordingly, poly-ALA was added to a dimethyl ether (DME) solution to form a transparent yellow solution.

### Example 1

A negative electrode with a thickness of 20 μm was formed with lithium. 0.1% by weight of poly-ALA, based on the total weight of the coating solution, was added to form a coating solution. The coating solution was applied to the surface of the negative electrode by a dropping method and dried under vacuum at room temperature to form a negative electrode coating layer. At this time, the polymer loading level of the negative electrode coating layer was 0.025 mg/cm². A lithium metal provided with a coating layer was used as a negative electrode to produce a coin cell for testing. A positive electrode was formed using LiCoO₂, PVdF and carbon (91.5:4.1:4.4, wt. %) and was coated on an aluminum foil with a thickness of 15 μm. A polypropylene separator (thickness 20 μm) and the positive electrode were stacked on the lithium negative electrode and a liquid electrolyte [1M LiPF₆ in EC/DEC (EC and DEC are mixed in a volume ratio of 1:1)] was injected to form a coin cell.

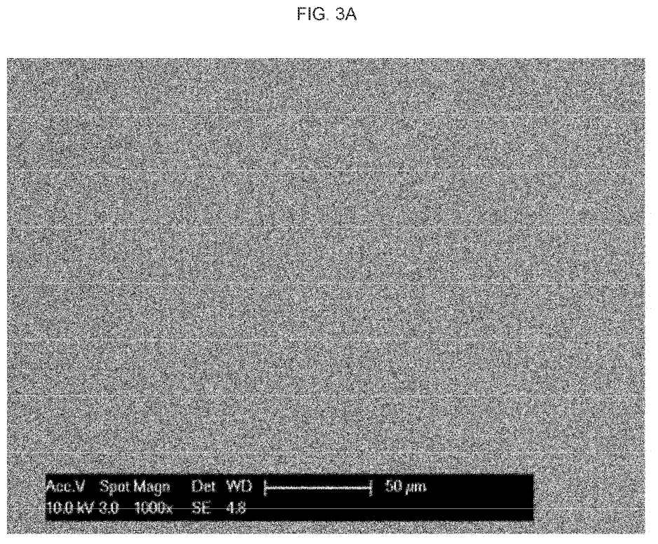

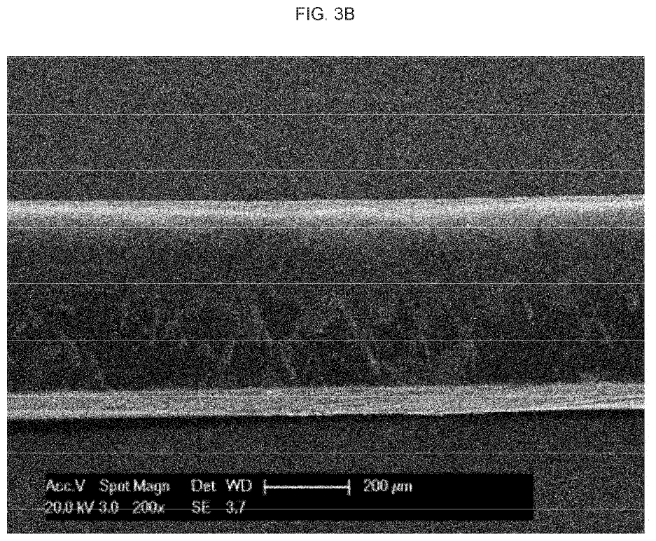

SEM analysis results of the surface of the negative electrode coating layer are shown in FIG. 3A, and SEM analysis results of side surfaces of the negative electrode and the negative electrode coating layer are shown in FIG. 3B. As can be seen from FIGS. 3A and 3B, the surface of the negative electrode coating layer is uniform and smooth, and a negative electrode coating layer is formed on the surface of the negative electrode.

### Example 2

The same process as in Example 1 was conducted except that the coating solution was formed by supplying 1% by weight of poly-ALA, based on the total weight of the coating solution. At this time, the loading level of the negative electrode coating layer was 0.25 mg·cm⁻².

### Example 3

A negative electrode coating layer was formed using lithium with a thickness of 450 μm in the same manner as in Example 1. The produced lithium-coated negative electrode was stacked to face another lithium-coated negative electrode such that a polypropylene separator was interposed there between, and a liquid electrolyte [1M LiPF₆ in EC/DEC (EC and DEC are mixed in a volume ratio of 1:1)] was injected to produce a lithium symmetric cell.

### Comparative Example 1

The same process as in Example 1 was conducted except that the negative electrode coating layer was not formed.

### Comparative Example 2

The same process as in Example 3 was conducted except that an electrolyte layer was formed using 1M LiTFSI in dioxolane (DOL)/dimethoxyethane (DME).

### Comparative Example 3

The same process as in Example 3 was conducted except that the negative electrode coating layer was not formed.

Measurement of Physical Properties

1. SEM Analysis

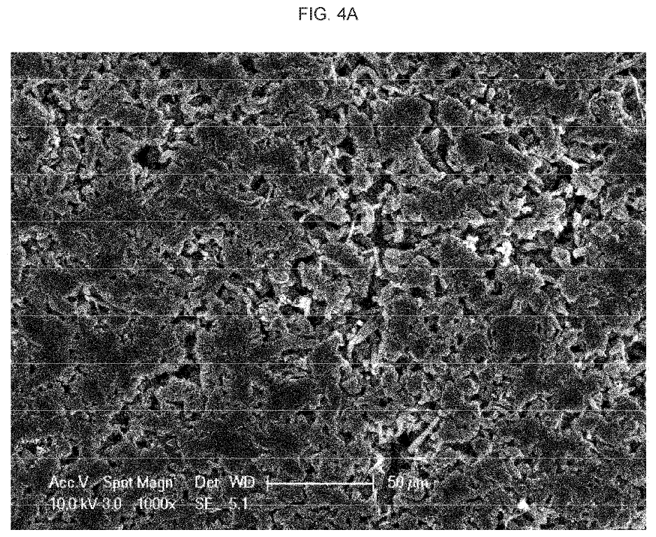

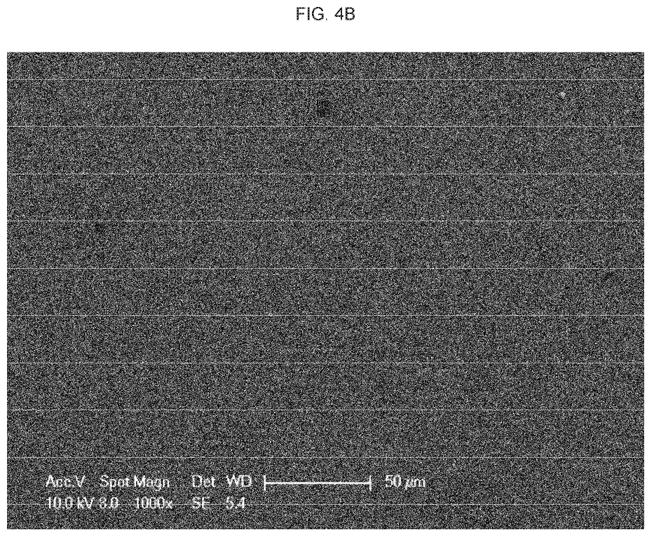

5 charge/discharge cycle testing was conducted, SEM analysis was conducted on the surface of the negative electrode coating layer of Example 1, SEM analysis results are shown in FIG. 4A, SEM analysis was conducted on the surface of the negative electrode coating layer of Comparative Example 1, and SEM analysis results are shown in FIG. 4B.

As can be seen from FIGS. 4A and 4B, in Comparative Example 1, a dendrite structure and a porous membrane (porous layer) are formed, and adhesiveness between the porous membrane and the negative electrode is deteriorated. On the other hand, in Comparative Example 2, the porous membrane remains due to the negative electrode coating layer, and the surface of the negative electrode also maintains gloss.

2. Charge/Discharge Testing

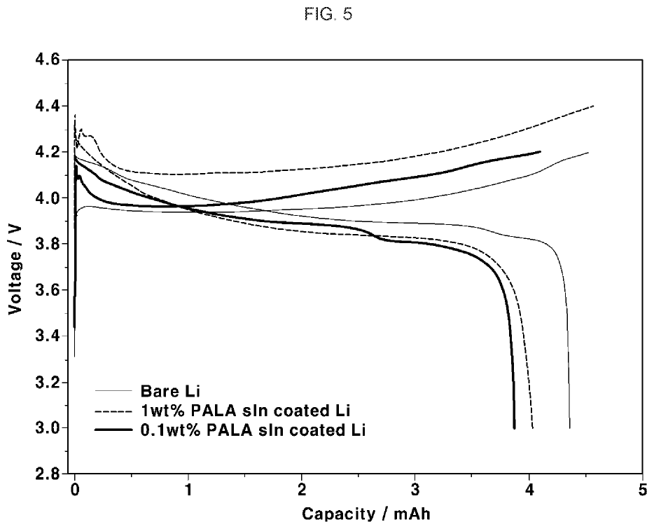

Charge/discharge testing was conducted under the condition of 0.34 mA·cm⁻² on the structures of Examples 1 and 2, and Comparative Example 1, and results are shown in FIG. 5. As can be seen from FIG. 5, as compared to Examples 1 and 3, and Comparative Example 1, high charge/discharge capacity was obtained.

3. Evaluation of Electrolyte Suitability

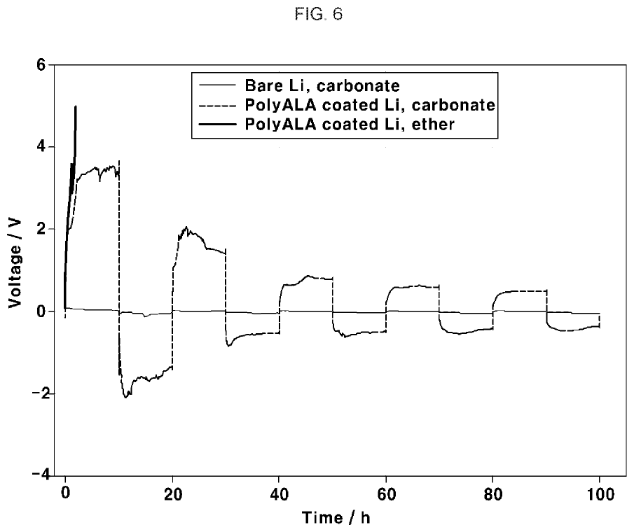

Voltages of Example 3, Comparative Example 1 and Comparative Example 2 were measured under conditions of 0.1 mA·cm⁻² and 10 hour/half-cycle, and results are shown in FIG. 6. Comparative Example 2 showed higher over-potential than Comparative Example 1 and a gradual decrease in over-potential as cycle count increases. That is, in Comparative Example 2, cell operation is impossible. This is considered to be due to the fact that the negative electrode coating layer is dissolved in DME, which increases resistance in the cell.

In Example 3, over-potential was 0.5V or less, the negative electrode coating layer was not dissolved, and cycles were stably operated.

As apparent from the foregoing, the lithium secondary battery for vehicles according to an embodiment of the present invention can improve reversibility of lithium, lengthen lifespan and increase charge/discharge capacity.

According to the method for manufacturing the lithium secondary battery for vehicles according to an embodiment of the present invention, a lithium secondary battery which can improve reversibility of lithium, lengthen lifespan and increase charge/discharge capacity can be provided.

Embodiments of the invention has been described in detail. However, it will be appreciated by those skilled in the art that changes may be made in these embodiments without departing from the principles and spirit of the invention, the scope of which is defined in the appended claims and their equivalents.

What is claimed is:

1. A lithium secondary battery for vehicles comprising:
a negative electrode comprising lithium;
a negative electrode coating layer provided over the negative electrode and comprising a disulfide polymer;
an electrolyte layer provided over the negative electrode coating layer; and
a positive electrode provided over the electrolyte layer.

2. The lithium secondary battery for vehicles according to claim 1, wherein the disulfide polymer is represented by the following Formula 1: 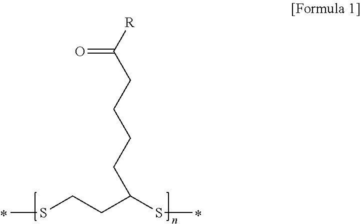
wherein R is —OXₐ or —NHX_{b},
in which Xₐ is an element selected from the group consisting of H, Li, Na, K, Cs, Ca, Mg, Fe, Co, Ni, Cu, Zn, Al or mixtures thereof, and
X_{b} is a functional group selected from the group consisting of halogen, an aryl group, an aralkyl group, a phenyl group, or mixtures thereof.

3. The lithium secondary battery for vehicles according to claim 1, wherein the disulfide polymer has a molecular weight of about 1,000 to about 10,000,000.

4. The lithium secondary battery for vehicles according to claim 1, wherein a polymer loading level of the negative electrode coating layer is about 0.025 mg/cm² to about 0.25 mg/cm².

5. The lithium secondary battery for vehicles according to claim 1, wherein a mass loading level of the negative electrode coating layer is about 1 μg·cm⁻² to about 1,000 μg·cm⁻².

6. The lithium secondary battery for vehicles according to claim 1, wherein the negative electrode coating layer has a thickness smaller than that of the negative electrode.

7. The lithium secondary battery for vehicles according to claim 1, wherein the negative electrode coating layer further comprises an inorganic substance.

8. The lithium secondary battery for vehicles according to claim 7, wherein the inorganic substance comprises at least one of Al₂O₃, SiO₂, TiO₂ or mixtures thereof.

9. A method for manufacturing a lithium metal air battery for vehicles comprising:
providing a negative electrode comprising lithium;
providing a negative electrode coating layer comprising a disulfide polymer over the negative electrode;
providing an electrolyte layer over the negative electrode coating layer; and
providing a positive electrode over the electrolyte layer.

10. The method according to claim 9, wherein, in the providing the negative electrode coating layer, the disulfide polymer is represented by the following Formula 1: 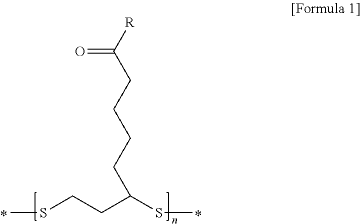
wherein R is —OXₐ or —NHX_{b},
in which Xₐ is an element selected from the group consisting of H, Li, Na, K, Cs, Ca, Mg, Fe, Co, Ni, Cu, Zn, Al, or mixtures thereof, and
X_{b} is a functional group selected from the group consisting of halogen, an aryl group, an aralkyl group, a phenyl group, or mixtures thereof.

11. The method according to claim 10, wherein the providing a negative electrode coating layer comprises:
preparing a cyclic disulfide monomer represented by the following Formula 2: 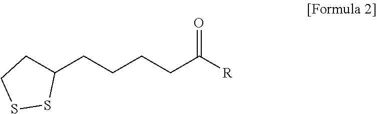
wherein R is —OXₐ or —NHX_{b}, in which Xₐ is an element selected from the group consisting of H, Li, Na, K, Cs, Ca, Mg, Fe, Co, Ni, Cu, Zn, Al, or mixtures thereof, and X_{b} is a functional group selected from the group consisting of halogen, an aryl group, an aralkyl group, a phenyl group, or mixtures thereof; and
polymerizing the cyclic disulfide monomer to form the disulfide polymer represented by Formula 1.

12. The method according to claim 11, wherein the formation of the disulfide polymer is carried out by applying heat or light.

13. The method according to claim 11, wherein the formation of the disulfide polymer is carried out at about 100° C. to about 140° C. for about 2 hours to about 4 hours.

14. The method according to claim 9, wherein, in the providing a negative electrode coating layer, the disulfide polymer has a molecular weight of about 1,000 to about 10,000,000.
